(19) United States
(12) Patent Application Publication
(10) Pub. No.: US 2022/0111843 A1
(43) Pub. Date: Apr. 14, 2022

(54) SYSETEM FOR SPEED CONTROL OF ELECTRIC BIKES , ELECTRIC SCOOTERS, AND SIGN RECOGNITION FOR ELECTRIC VEHICLES , AUTONOMOUS VEHICLES IN CITIES ,AND HIGHWAYS

(71) Applicants: SHIV P VERMA, CEDAR KNOLLS, NJ (US); SHAILEN VERMA, RUMSON, NJ (US)

(72) Inventors: SHIV P VERMA, CEDAR KNOLLS, NJ (US); SHAILEN VERMA, RUMSON, NJ (US)

(21) Appl. No.: 17/557,591

(22) Filed: Dec. 21, 2021

Related U.S. Application Data
(60) Provisional application No. 63/130,558, filed on Dec. 24, 2020.

(51) Int. Cl. B60W 30/18; G08G 1/0968

(52) U.S. Cl. CPC B60W 30/18009; G08G 1/096861; B60W 2420/42; B60W 2554/4049; B60W 2554/4029

(57) ABSTRACT

A system for speed control of electric bikes, electric scooters and road sign recognition for connected vehicles is presented in this invention. A web server system containing all the information on the road signs and traffic lights under the city's jurisdiction with street map is used. This server controls a controller installed on all the road signs and road traffic lights. This controller uses an ISM band transmitter to transmit content of the posted road sign as multiple data packets. These data packets are used by the controller installed in the vehicle to determine type of road signs and then inform the vehicle main system controller to perform appropriate operation for speed control and operation of the vehicle.

### BACKGROUND

Global concerns with climate changes by citizens and countries around the world has made every nation to think about alternate sources for fossil fuel to reduce carbon emissions to save our planet. This has generated great interest in renewal energy sources for power generations and alternate source for new mode of transportations in metro cities and countries. It has also given lot of initiative for new start up to look at new technology for Bicycles, Scooters and fossil fuel powered vehicles. Now we can see electric Bicycles (e-Bikes), electric Scooters (e-Scooters) and Electric Vehicles (EV) plying on our nation's highways and city's streets. They make use of the latest development in lighter and high capacity battery technologies, multi core computers, System on chip semiconductors to give higher speeds, longer driving distances without recharge. Charging Stations are popping across the countries to facilitate users of EV's.

E-Bikes and e-Scooters can go forty to fifty miles an hour speeds, and are causing accidents in the city's streets and killing pedestrians as well drivers. This is causing city governments concerns and they are looking for ways to control their speeds to follow speed signs and traffic signals. Some cities in Europe are creating ordinances for the Batteries to be turned off once they enter in the city limits and asking drivers to pedal them to curve road accidents and deaths. Dutch government is piloting such technology which has met lot of resistance from drivers, as some places the head wind can be as high as 48 km/h making hard to pedal manually.

New York State allows e-Bikes and e-Scooters on highways and city streets with posted speed limits of 30 MPH or less. According to the US Consumer Product Safety Commission, at least 41 Americans were killed and about 133000 injured between 2017 and 2019 in incidents tied with e-Bikes and e-Scooters. This number will go up as more people start riding them and thus a solution is needed to control these incidents in the city and state highways. A system and method to control automatically speeds of these electric assisted Bikes and Scooters is needed without sacrificing the flexibility offered by them to their riders.

All domestic and international automotive manufacturers and new start up like-TESLA, are selling Electric Vehicles (EVs) and offering Advanced Driving Assistance System (ADAS) features in the vehicles and slowly moving towards driver-less vehicles, known as Connected or Autonomous Vehicles (AVs). These vehicles use specialized Cameras, Radar and Lidar with sophisticated Artificial Intelligence, AI, algorithms running on a very powerful multicore Servers to recognize traffic and road signs in these Autonomous Vehicles (AVs), and non-Autonomous Vehicles against the road sign database stored in these Servers in the vehicle or Clouds. All this sophisticated and expensive hardware and software makes fatal operating decision because image recognition result is not hundred percent accurate. And these decisions further result in fatal errors in inclement weather such as rain, snow and fog. The database for these signs varies in different countries with different language and signs. It is also a nightmare to keep them up to date as new signs are added regularly by the city, town and highway authorities of a country. This also creates a problem when a temporary detours is installed, and police personnel directing traffic in case of an emergency or accident. The U.S. Pat. No. 10,762,363 B2 by Kosuke Watanabe tries to solve inaccuracy in recognition of road signs by suggesting that all the near-by cars on the road share their sign recognition results and thus by getting weighted average of these results to increase accuracy. This calls for all the vehicles on the road sharing road sign recognition using Vehicle to anything (V2X) protocol. And still the recognition accuracy is not one hundred percent. And what happens when you are alone on the road with no other AV. A simple universal accurate method to recognize road signs and traffic light is desirable for AV to become a viable option on all the roads and in all weather conditions. All this requires high speed real time processing which can cause further problems for electric vehicles. In this invention a system and method is described to solve this problem. The invention described reduces the processing burden on the EV computers and thus reduces the power drain on the battery enabling larger driving range without recharge.

### SUMMARY

A system for speed control of Electric Bikes, Electric Scooters, and road sign recognition for connected vehicles is described in this invention. A web server which has map of all road signs, traffic lights on the city streets and highways in its jurisdiction is used. All these road signs, and traffic lights have a controller installed. This controller is powered by an energy harvester and requires no power from outside source for operation. It has a data modem to communicate with the web server. The web server can program all the contents of the road signs. For example a road sign can be of speed limit, one way, stop sign, curving road with speed limit, the content of stop sign can be one way, two way, three way and four way. It also has GPS location of the sign. The controller has an Industrial Scientific and Medical, ISM, frequency band transceiver, such as 5.9 GHz band. This transceiver is used to broadcast multiple data packets giving information on the content of the sign. Frequency of this broadcast is controlled by the web server in a way that there is no collision with the other signs on that street. A similar controller is installed at all the traffic lights, and transceiver on the controller transmits multiple packets giving the status of the traffic light i.e. R, A, G.

All Electric Bikes and Scooters have another controller with ISM frequency band transceiver, such as 5.9 GHz to listen to all packets transmitted by the road signs on the street and to detect the speed limit, and type of street signs. It uses its own GPS to compute its speed and then alert its main system controller to conform vehicle's speed together with the posted one. It can also alert rider directly or through the main system controller about the state of the traffic light as well approaching stop signs. A smart camera module with its AI to recognize face, objects and scenes is used to alert the EV drivers about pedestrian, and other hazards.

Autonomous and non-Autonomous Electric Vehicles use a similar controller to detect type and content of the road signs and traffic lights. This information is used by the vehicle's Advanced Driver Assistance System, ADAS, system that makes accurate operating decisions for the vehicles on the city streets or highways.

The web server controls the transmit power and radiation pattern, of road signs and road traffic lights ISM band transmitters, to provide enough detection range for the vehicles on the roads and highways.

### BRIEF DESCRIPTION OF DRAWINGS

The disclosure is illustrated by the way of example, and not by the way of limitations in the figures of the accompanying drawings in which like numerals are used to refer to similar elements.

FIG. 1 is a block diagram illustrating the proposed system of the invention.

FIG. 2 is a block diagram of controller mounted or incorporated in all the road signs and traffic lights.

FIG. 3 is a block diagram of a controller embedded in all e-Bikes, e-Scooters, EVs and AVs.

### DETAILED DESCRIPTION

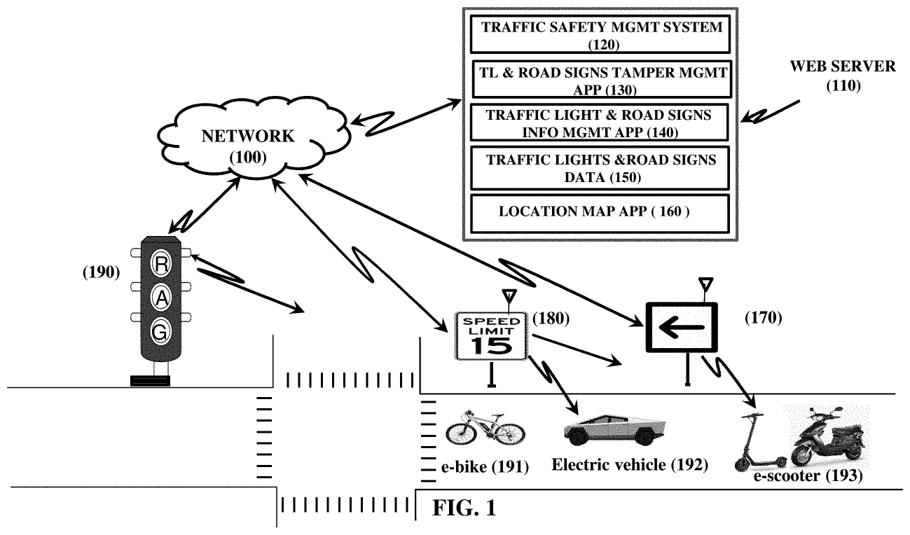

Embodiment of a System to control the speed of e-Bikes, e-Scooters and road sign recognition in Electric Vehicles and Autonomous Vehicles is shown in FIG. 1. A city web server (110) is connected to a broadband internet and wireless network (100). This server controls embedded controller installed on all road signs (170), (180) and traffic lights (190). The server (110) has applications which manages location map of city streets, road signs on each street like-Stop signs, One Way, Speed limit, Bump etc., (160), (150). It also has location of traffic lights. A similar server is used for highways controlled by the State Authorities. All these road signs (RS) controllers is programmed for their functions remotely by the server, (110) using Traffic Light and Road Signs management application (140). This application programs these Road Signs for speed limits on the time of the day and days of week, if these signs have electronic display. Any tampering of these controllers is alerted to the Tamper Management Application (130).

Wireless Network of this Network, (100), can be a private dedicated network using Industrial Scientific Medical (ISM) frequency band or standard public cellular 3G, 4G, 5G, and any derivatives.

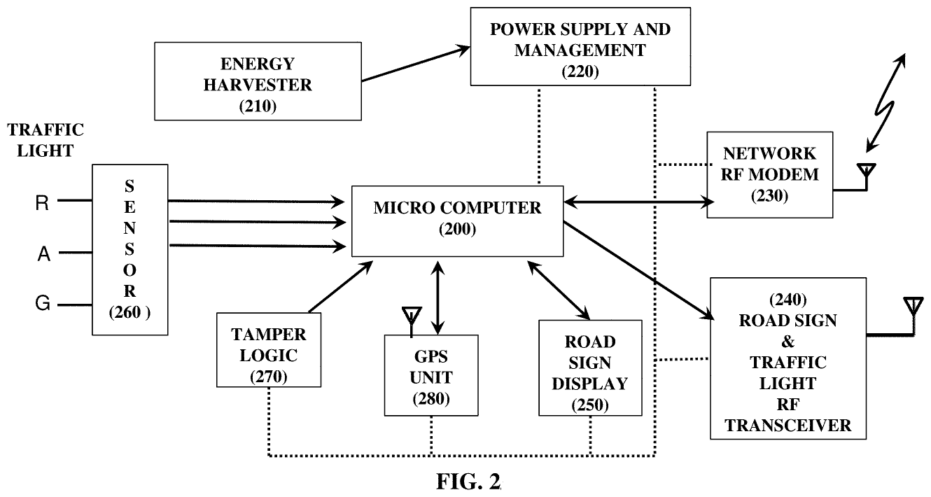

Controller of FIG. 2 is installed on every road signs. It has a RF transceiver, (240), operating in ISM frequency band, such as 5.9 GHz band, and it is used to transmit multiple packets of data each containing GPS location of the sign, function types-such as speed, and allowed speed limit etc. These packets are transmitted every few milliseconds to seconds as a radio beacon for e-Bikes, e-Scooters, EVs, AVs plying on the street to follow the posted functions. The Traffic Safety Management application, (120), in the server, (110), controls the frequency of sequencing of these radio packets to avoid any collision among multiple signs and traffic lights (TL) posted on that street. The transmit power and radiation pattern of the antenna of the road sign installed controllers is individually controlled by server, (110) to control the transmission range as needed for the street and weather conditions.

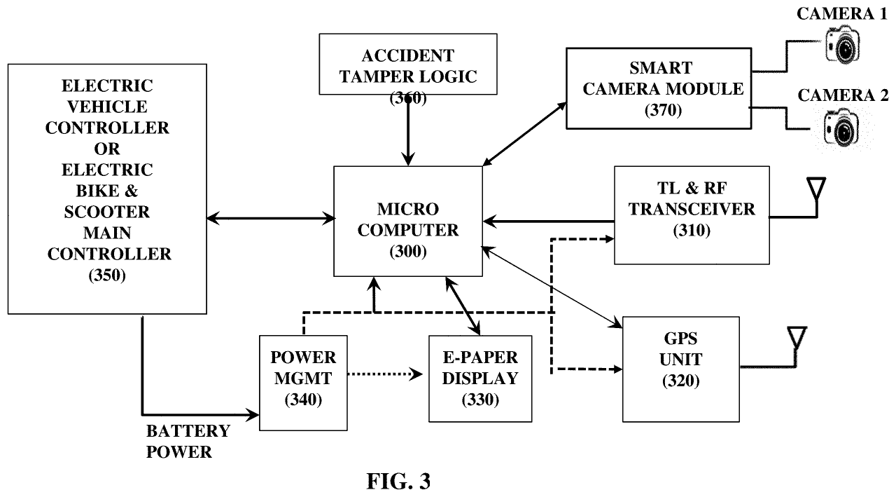

All the e-Bikes, e-Scooters, EVs, and AVs have a controller of FIG. 3 installed to receive data packets broadcasted by Traffic Lights and Road Signs installed on the streets and they use same ISM frequency band transceiver e.g. 5.9 GHz. The controller use information from the road sign transmitters about the posted speed limits and uses its own GPS to compute the speed to inform the e-Bikes, and e-Scooter's main system controller to limit the speed to the posted limit. The controller can communicate with the city's web server, (110), via installed posted sign. It uses V2X type protocol on ISM band transceiver to talk to street signs and street signs uses its RF modem to talk to city's Web Server, 110.

The traffic Light controllers installed on the intersections traffic lights have a radio data modem transceiver operating in the same ISM band e.g. 5.9 GHz, and it transmits multiple data packets every few milliseconds to few seconds with the status of traffic signal light, GPS location, duration of that signal state, time stamp. This allows EVs and AVs controller to calculate the distance from the traffic signal light to control stopping action before it reaches the intersection. EVs and AVs on the street gets information on the types of signs and can inform the vehicle's ADAS system with accuracy to pilot the vehicle and it frees up Radar, Lidar and Cameras for other tasks. This reduces the processing power required for the servers at AVs and EVs, and reduces the battery power drain, thus increasing the vehicle's driving range.

FIG. 2 gives block diagram of road sign and traffic signal light controller. It is installed on every road signs, and traffic light signal. A microcomputer, (200), with its embedded firmware and operating system controls all the peripherals devices and logic. RF and solar energy harvester, (210), with super capacitors produces enough power to the controller. Power Management is done by module, (220). Network RF modem communicates with the Server, (110), and road sign/traffic light ISM band RF transceiver, (240), broadcasts multiple data packets every few milliseconds to few seconds. These data packets contain information about the type of road signs, speed limit and its traffic GPS location, which is used by the controller in the vehicle to maintain the speed within the posted limits. The transmit power and antenna radiation pattern is controlled by the server, (110), to assure it covers the street or distance on the highway in different weather conditions. GPS unit, (280), provides the traffic light location. The Red, Amber, Green signal sensors, (260), provides the status of the traffic light and duration of that status. Tamper Logic, (280), detects any tamper attempts and alerts the server (110), for action. This controller is also mounted on an emergency cones to alert emergency conditions and detours for vehicles ADAS system to follow.

This circuitry is on a single printed circuit board and in some embodiment it can be part of e-paper based display, (250). In other embodiments whole function is integrated on a system on chip (SoC) with standalone unit or embedded with electronic road sign. This controller can be integrated on the highway overhead signs in some embodiments, and thus EVs and AVs get accurate and reliable recognition of traffic signs traveling on the streets or highways.

FIG. 3 gives the block diagram of vehicle installed controller. It is used to communicate with the vehicle system about the posted speed limits and recognized road signs. This controller is a standalone device or integrated as a sub unit of an e-Bike, e-Scooter, electric vehicle communicating with the main system computer of these vehicles. It will provide road sign recognition, speed limits, traffic signal light status and other road signs posted on the city streets and highways. The controller's microcomputer, (300), controls all the modules and gets power from the main system of the vehicles. The radio transceiver, (310), listens to all data packets broadcast from the road signs and traffic lights controllers on the street or highway the vehicle is moving. These data packets give the posted speed limits on the street, speed bumps with speed limit and GPS locations. The microcomputer, (300), uses this information, calculates vehicle speed using its GPS unit, (320), and informs main system to control the vehicle speed. In case of e-Bike or e-Scooter, this information is used by the system controller to lock the gear shift in a mode to conform the posted speed.

The smart camera module, (370), is a AI powered image camera module and it supports multiple camera sensors. It has built in AI based chips for object detection, segmentation, or facial recognition. The camera sensors are mounted on the front and back of the EV to detect any hazards to the drivers and pedestrians. Module does all Image Signal Processing, ISP, and deep learning based Convolutional Neural Network, CNN engine to detect any threat from other EVs and alert the driver. The controller can alert the Web Server, (110), about any accident and transmit images to it. Built in accident logic, (360), is also used in alerting the Web Server, (110). The controller uses ISM band RF transceiver, (240), to send messages to server, (110), using V2X protocol to a nearby traffic sign, which routes it to the Server, (110), using RF modem link.

The Vehicle Controller can also alert the bike rider. The data packets received from the traffic signal light allows controller to communicate with the vehicle ADAS System status of signal light, duration, vehicle speed and distance from intersection. This allows ADAS System to make appropriate maneuvers. This controller relieves AV's and EV's Radar, Cameras, Lidar and associated servers from the task of traffic signs and traffic light recognition. And it provides accurate indications of road signs and traffic lights. The e-bike rider will get alert for the traffic light status and e-bike's system controller can lock gear to conform to status of traffic light. Any effort to disable or tamper with the controller will create audible sound and generate alerts to system web server. In some embodiments this controller can be integrated with the main controller or handle bar based gear shift display of e-bike, e-scooter. It can also be a standalone unit mounted on the dash board of an EV.

What is claimed is:

1. A web server based system for speed control of Electric Bikes, Electric Scooters, and traffic signs and traffic light status recognition, for Electric Vehicles, Autonomous Vehicles on city streets and highways, the system comprising;
a traffic sign and traffic light controller installed on every road sign and traffic light comprising,
a microcomputer, with a GPS unit,
a network RF data modem,
an ISM band RF data transceiver,
a RF and solar energy harvester,
a tamper detection logic,
a set of embedded firmware to communicate with web server and vehicle controllers, and to broadcast multiple of data packets containing location of the sign/traffic light, type of sign and speed limit, status and time stamp every few milliseconds to few seconds;
a vehicle controller mounted on every vehicle comprising,
a microcomputer with GPS unit,
a ISM band Data RF transceiver,
a temper detect logic, accident detect logic and alert devices,
a interface with the vehicle system controller to alert for the speed and type of sign for it to act,
a smart camera module with its own AI coprocessors for image processing and supporting multiple camera sensors to protect driver and pedestrians from harm,
a set of embedded firmware to transmit and receive all data packets, interpret them and communicate the result to the vehicle system to react;
at least a web server comprising of a multi core single server or separate servers,
at least one city traffic safety management server with application to configured to handle communication with all the
road sign and traffic light controllers, application to manage city traffic signs speed limits,
traffic lights features, traffic signs and traffic light data packets broadcast intervals, application to city and state street and highway map, application to manage all alerts originating from traffic signs, traffic lights, vehicles,
a data base server to maintain city traffic road signs, city traffic lights.
